(19) United States
(12) Patent Application Publication
(10) Pub. No.: US 2024/0309684 A1
(43) Pub. Date: Sep. 19, 2024

(54) Door Block

(71) Applicant: Angel Ernesto Arevalo, Charlotte, NC (US)

(72) Inventor: Angel Ernesto Arevalo, Charlotte, NC (US)

(21) Appl. No.: 18/333,409

(22) Filed: Jun. 12, 2023

Related U.S. Application Data
(63) Continuation-in-part of application No. 29/872,766, filed on Mar. 17, 2023.

(51) Int. Cl. E05C 17/54

(52) U.S. Cl. CPC E05C 17/54

(57) ABSTRACT

A door holding apparatus comprising a block and a magnet. The door holding apparatus is configured to be positioned on the hinge of a door between the door and the frame, holding the door in an open position. The block of the door holding apparatus is substantially cube shaped comprising a top surface, a bottom surface, a first exterior wall, a first interior wall, a second exterior wall, a second interior wall forming the faces of a rectangular prism. The block further comprises a slanted wall positioned between and angularly offset from the first interior wall and the second interior wall. The magnet is arranged within a magnet recess positioned on one of the block walls or surfaces, allowing the block to be magnetically attached to a metal door hinge.

### FIELD OF THE INVENTION

The present invention relates generally to door accessories and child safety devices and specifically to an apparatus for holding or wedging a door open.

### BACKGROUND OF THE INVENTION

Many instances call for doors to be held open that are designed to automatically close. Presently, heavy objects are often placed in front of an open door or wedges are placed between the bottom of the door and the floor, using friction with the floor to keep the door from closing. These tools and methods are successful in some circumstances but have shortcomings in situations with particularly heavy doors or limited clearance between the door and the floor. Further, having a weighted object or wedge in front of a door may crowd the doorway, leading to passersby tripping over the object or knocking it away from the door. Additionally, when objects such as these are unwillingly removed from a door, the hinge may become a safety hazard for children.

The present invention is a door holding apparatus utilized at the hinge of a door to wedge or hold the door away from the frame, overcoming the limitations of current door holding solutions.

### BRIEF DESCRIPTION OF THE DRAWINGS

FIG. 1 is a top front isometric view of the present invention in accordance with at least one embodiment.

FIG. 2 is a bottom rear isometric view of the present invention in accordance with at least one embodiment.

FIG. 3 is a front elevation view of the present invention in accordance with at least one embodiment.

FIG. 4 is a rear elevation view of the present invention in accordance with at least one embodiment.

FIG. 5 is a top plan view of the present invention in accordance with at least one embodiment.

FIG. 6 is a bottom plan view of the present invention in accordance with at least one embodiment.

FIG. 7 is a left-side elevation view of the present invention in accordance with at least one embodiment.

FIG. 8 is a right-side elevation view of the present invention in accordance with at least one embodiment.

FIG. 9 is top front isometric view of the present invention attached to a door hinge in accordance with at least one embodiment.

FIG. 10 is an illustration of the present invention attached to a door hinge in accordance with at least one embodiment.

FIG. 11 is an illustration of the present invention attached to a door hinge in accordance with at least one embodiment.

FIG. 12 is an illustration of the present invention attached to a door hinge in accordance with at least one embodiment.

### DETAIL DESCRIPTIONS OF THE INVENTION

All illustrations of the drawings are for the purpose of describing selected versions of the present invention and are not intended to limit the scope of the present invention.

The present invention is a door holding apparatus configured to be placed at the hinge of a door between a door and a frame in order to hold the door open relative to the frame, allowing users to easily pass through and preventing children or other users from pinching their fingers in the door hinge. The door holding apparatus generally comprises a block 1 and a magnet 3. The block 1 is preferably made of a pliable, non-rigid material such as foam or silicone, allowing the block 1 to partially deform during use.

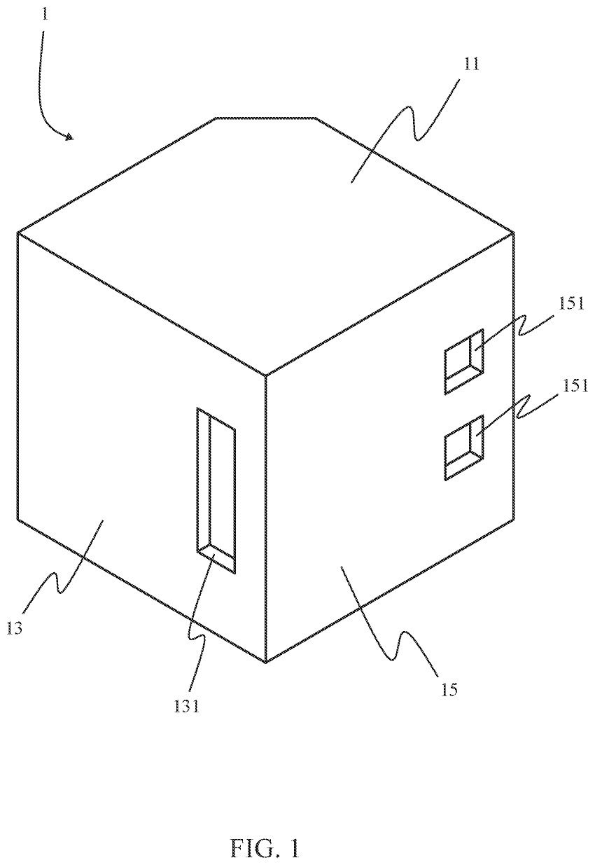

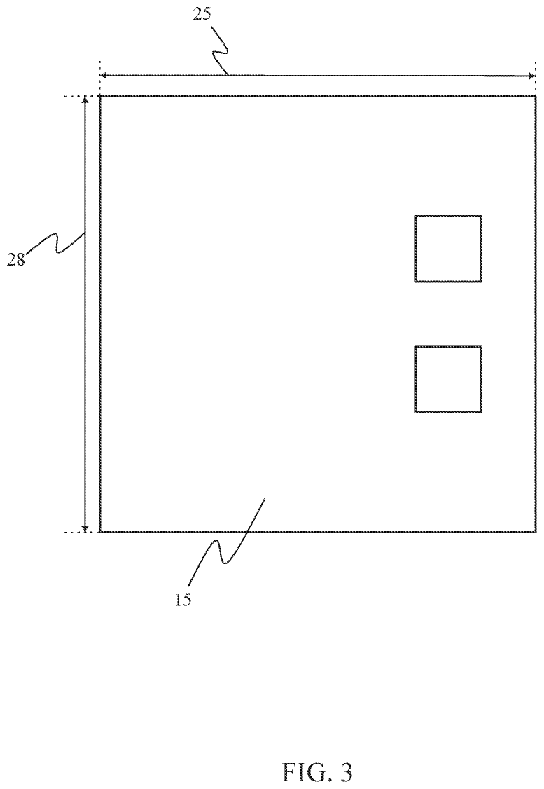

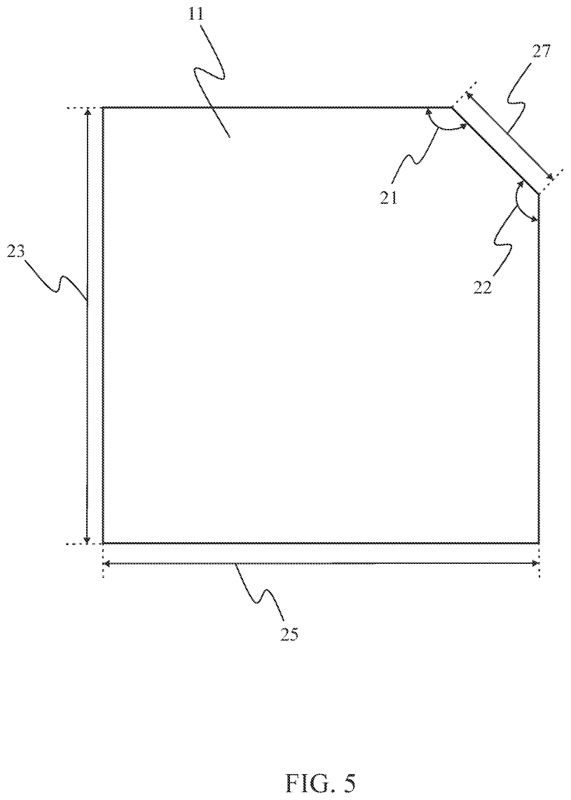

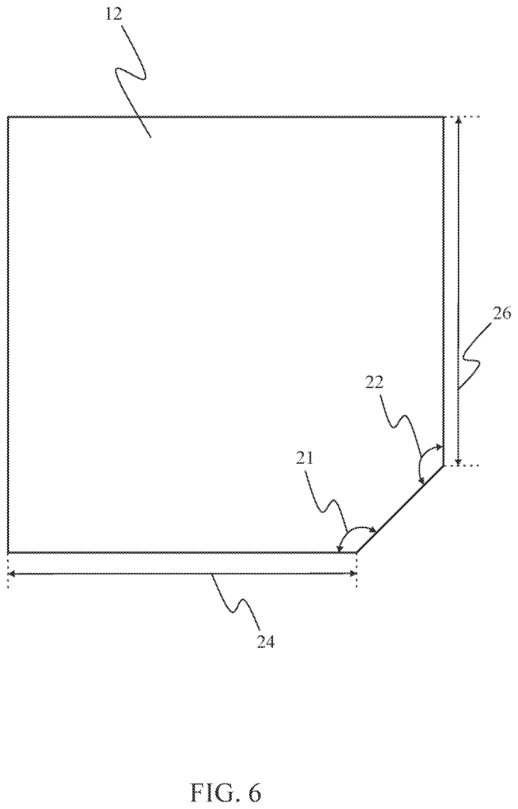

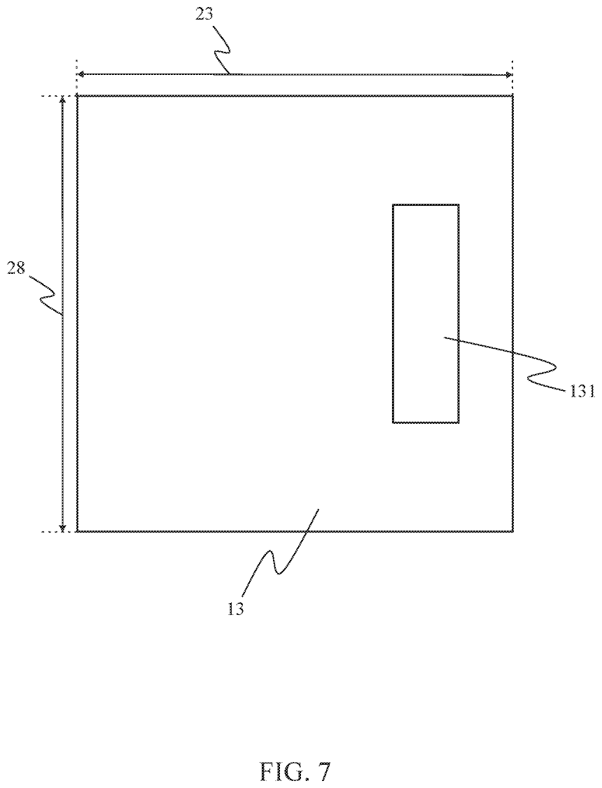

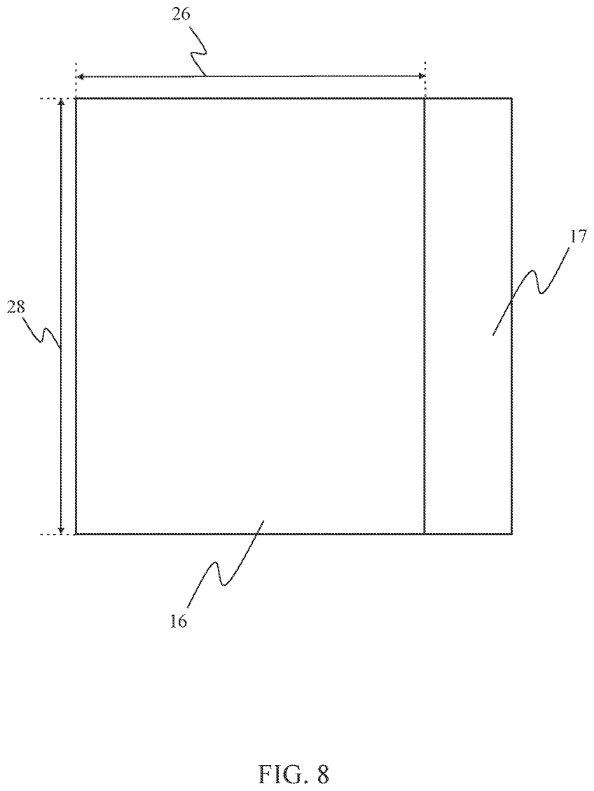

Referring to FIG. 1-9, the block 1 of the present invention comprises a top surface 11, a bottom surface 12, a first exterior wall 13, a first interior wall 14, a second exterior wall 15, a second interior wall 16, and a slanted wall 17. In the preferred embodiment, the block 1 is substantially a rectangular prism with the slanted wall 17 replacing one edge. The top surface 11 is oppositely positioned from the bottom surface 12 about the block 1, the first exterior wall 13 is oppositely positioned from the second interior wall 16 about the block 1, the second exterior wall 15 is oppositely positioned from the first interior wall about the block 1, and the slanted wall 17 is positioned between the first interior wall 14 and the second interior wall 16, angularly offset from the first interior wall 14 and the second interior wall 16. Preferably, the top surface 11 and the bottom surface 12 are parallel to one another, the first exterior wall 13 and the second interior wall 16 are parallel to one another, and the second exterior wall 15 and the first interior wall 14 are parallel to one another. Further, the top surface 11 and the bottom surface 12 are each preferably perpendicular to the first exterior wall 13, the second exterior wall 15, the first interior wall 14, the second interior wall 16, and the slanted wall 17. Finally, the first exterior wall 13 and the second interior wall 16 are preferably perpendicular to the second exterior wall 15 and the first interior wall 14. In the preferred embodiment, the slanted wall 17 is a flat surface, though in alternative embodiments, the slanted wall 17 may be curved or otherwise concave. A first slanted angle 21 may be delineated between the slanted wall 17 and the first interior wall 14 and a second slanted angle 22 may be delineated between the slanted wall 17 and the second interior wall 16. The first slanted angle 21 and the second slanted angle 22 each preferably range from 30-60 degrees, with sum of the first slanted angle 21 and the second slanted angle 22 being 90 degrees to maintain the box shape of the block 1. In the preferred embodiment, the first slanted angle 21 and the second slanted angle 22 have equal measure of 45 degrees.

A first exterior length 23 is defined as the length of the first exterior wall 13 parallel to the top surface 11, a first interior length 24 is defined as the length of the first interior wall 14 parallel to the top surface 11, a second exterior length 25 is defined as the length of the second exterior wall 15 parallel to the top surface 11, a second interior length 26 is defined as the length of the second interior wall 16 parallel to the top surface 11, and a slanted length 27 is defined as the length of the slanted wall 17 parallel to the top surface 11. In the preferred embodiment, the first exterior length 23 is equal to the second exterior length 25 and the first interior length 24 is equal to the second interior length 26, though in alternative embodiments, these lengths may differ to create a rectangular shape rather than a substantially square shape. Further, the first interior length 24 and the second interior length 26 are each longer than the slanted length 27 and, in some embodiments, the first interior length 24 and the second interior length 26 are each at least twice as long as the slanted length 27. A block height 28 is defined as the length of the block 1 perpendicular to the top surface 11. In the preferred embodiment, the block height 28 is equal to the first exterior length 23 and the second exterior length 25, making the block 1 a substantially square shape, though in alternative embodiments, the block height 28 may be shorter or longer then the first exterior length 23 and the second exterior length 25, making the block 1 a more rectangular shape.

As shown in FIGS. 1, 3, 7, and 9, a plurality of exterior markings 100 may be positioned on the block 1. The plurality of exterior markings 100 are positioned on the block 1 in a manner that allows a user to correctly orient the present invention during use. Further, the plurality of exterior markings 100 may be used to display a brand name, logo, or other symbolic indicator. Preferably, the plurality of exterior markings 100 are cavities in the block 1, though they may also be protrusions or substantially flat markings. In the preferred embodiment, the plurality of exterior marking comprises a first exterior marking 131 and a second exterior marking 151. The first exterior marking 131 is positioned on the first exterior wall 13 and the second exterior marking 151 is positioned on the second exterior wall 15. The first exterior marking 131 and the second exterior marking 151 are different from each other in shape and or size, allowing a user to quickly identify between the first exterior wall 13 and the second exterior wall 15 in order to correctly orient the block 1 during use.

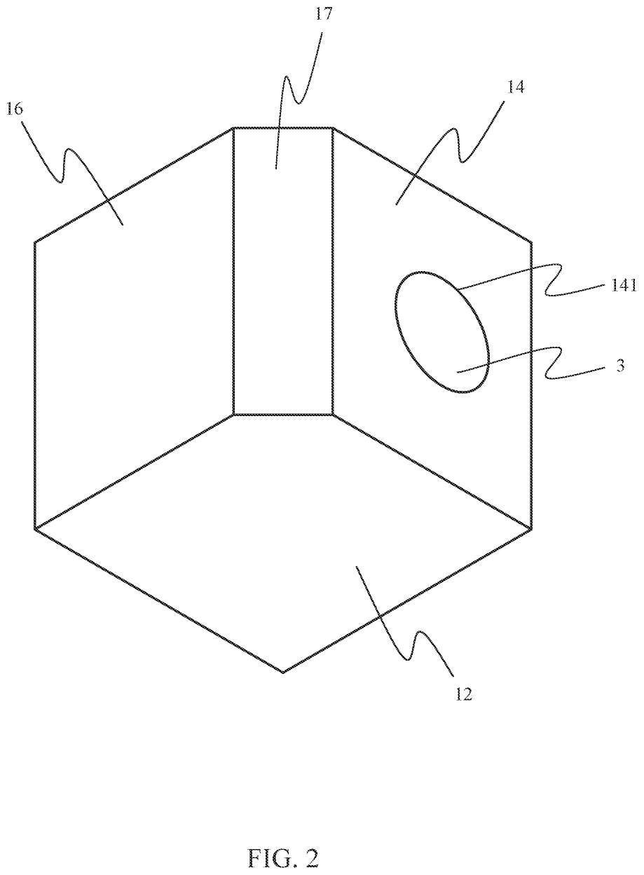

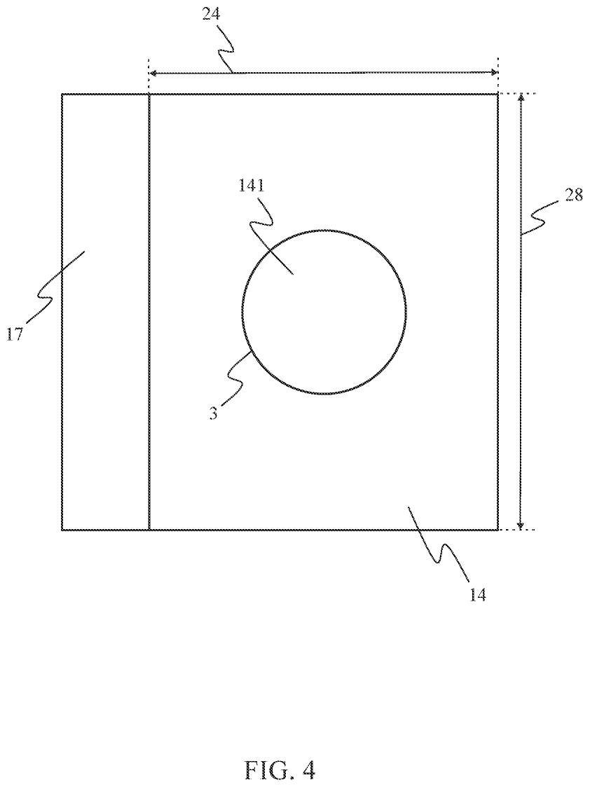

Referring to FIGS. 2 and 4, the magnet 3 of the present invention is a magnetic material configured to magnetically attract ferromagnetic metals. The block 1 of the present invention may comprise a magnet recess 141. The magnet recess 141 extends normal and into the block 1, creating a cavity in the block 1. Preferably, the magnet recess 141 is positioned on the first interior wall 14. The magnet recess 141 is preferably circular, though other magnet recess 141 shapes may be used. The magnet 3 is positioned in the magnet recess 141 and may be attached by an adhesive. In order to fit within the magnet recess 141, the magnet 3 is preferably cylindrical in shape, though other magnet 3 shapes may be used so long as the magnet 3 is capable of fitting within the magnet recess 141. In one embodiment of the present invention the magnet 3 sits flush with the first interior wall 14 when positioned within the magnet recess 141, though in other embodiments, the magnet 3 may protrude from the magnet recess 141 beyond the first interior wall 14.

The size of the block 1, including the lengths of any of the walls or surfaces may vary in different embodiments of the present invention in order to accommodate door, frame, and hinge sized and shapes. Further, the magnet 3 of the present invention may also vary in size and magnetic strength in order to accommodate doors or various sizes and weights.

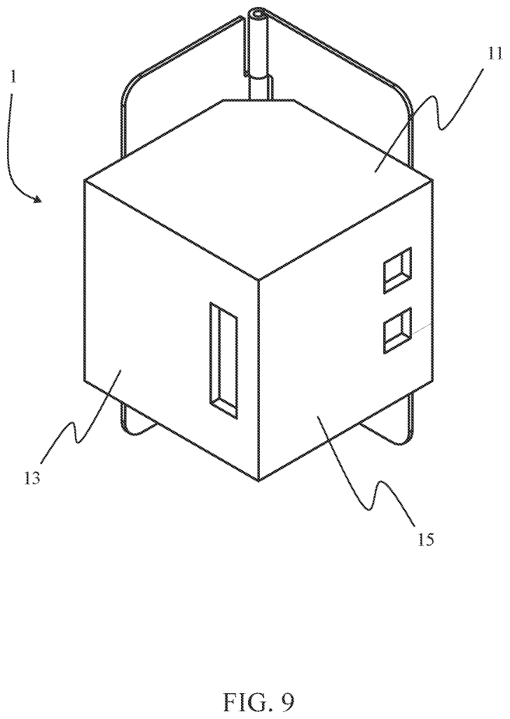

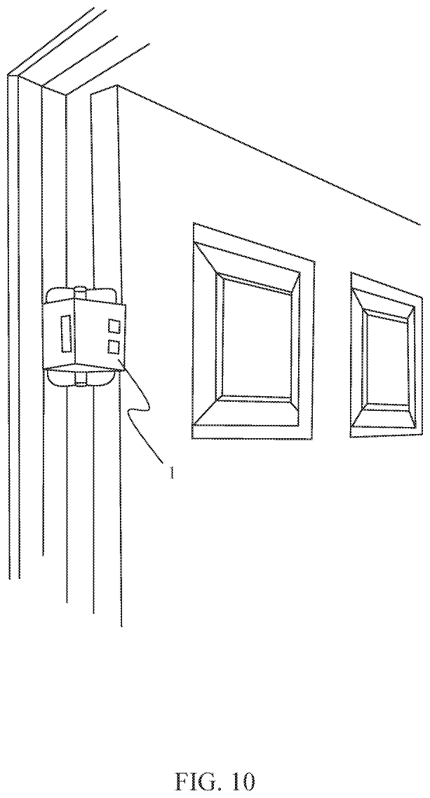

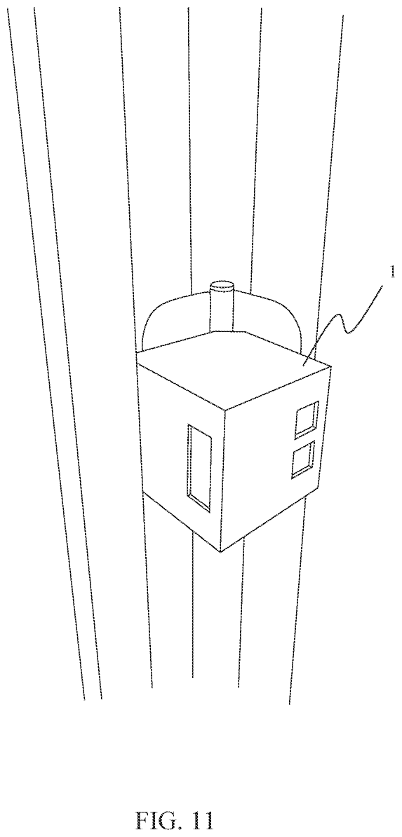

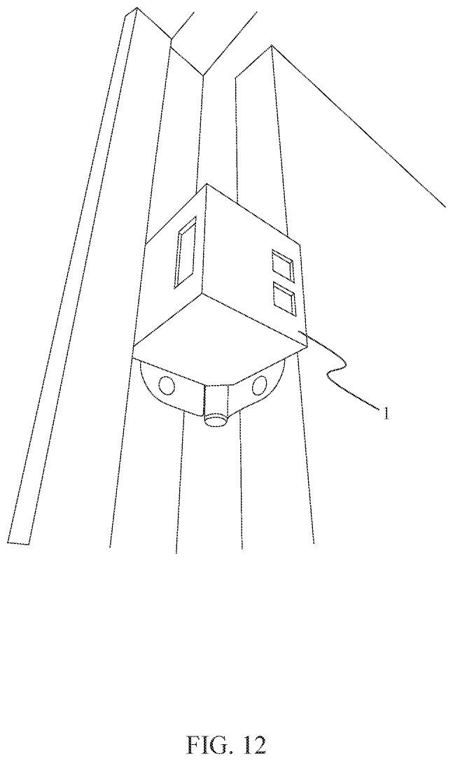

In use, with reference to FIG. 9-12, the present invention is placed on the hinge of a door, positioning the block 1 between the door and the frame, thereby preventing the door from closing into the frame. When placing the block 1 against the hinge, the block 1 is arranged so that the first interior wall 14 and the magnet 3 are placed against the hinge, creating a magnetic connection between the magnet 3 and the hinge. Preferably, the magnet 3 is arranged against the hinge plate on the frame side. Further, the slanted wall 17 is arranged against the axle of the hinge, creating a cutout for hinges that have protruding axles that would not fit a corner/edge. The second interior wall 16 is arranged against the hinge on the door side, leaving the first exterior wall 13 and the second exterior wall 15 exposed. This arrangement allows for the first exterior marking 131 and the second exterior marking 151 to be visible to a user when the block 1 is placed, ensuring that the block 1 is correctly oriented relative to the door, hinge, and frame.

Although the invention has been explained in relation to its preferred embodiment, it is to be understood that many other possible modifications and variations can be made without departing from the spirit and scope of the invention.

What is claimed is:

1. A door holding apparatus, comprising:
a block;
a magnet;
the block comprising a top surface, a bottom surface, a first exterior wall, a first interior wall, a second exterior wall, a second interior wall, and a slanted wall;
the top surface being oppositely positioned from the bottom surface about the block;
the first exterior wall being oppositely positioned from the second interior wall about the block;
the second exterior wall being oppositely positioned from the first interior wall about the block;
the slanted wall being positioned between the first interior wall and the second interior wall;
the slanted wall being angularly offset from the first interior wall;
the slanted surface being angularly offset from the second interior wall;
the block further comprising a magnet recess; and
the magnet being arranged within the magnet recess.

2. The door holding apparatus of claim 1, further comprising:
the top surface being parallel to the bottom surface;
the first exterior wall being parallel to the second interior wall;
the second exterior wall being parallel to the first interior wall;
the top surface being perpendicular to the first exterior wall;
the first exterior wall being perpendicular to the second exterior wall; and
the slanted wall being perpendicular to the top surface.

3. The door holding apparatus of claim 1, further comprising:
a first exterior length of the first exterior wall parallel to the top surface being equal to a second exterior length of the second exterior wall parallel to the top surface; and
a first interior length of the first interior wall parallel to the top surface being equal to a second exterior length of the second interior wall parallel to the top surface.

4. The door holding apparatus of claim 1, further comprising:
the magnet recess being positioned on the first interior wall; and
the magnet being flush with the first interior wall.

5. The door holding apparatus of claim 1, wherein the slanted wall is flat.

6. The door holding apparatus of claim 1, further comprising:
a first slanted angle between the first interior wall and the slanted wall being between 30 and 60 degrees; and
a second slanted angle between the second interior wall and the slanted wall being between 30 and 60 degrees.

7. The door holding apparatus of claim 6, wherein the first slanted angle and the second slanted angle are equal.

8. The door holding apparatus of claim 1, further comprising:
a first exterior marking;
a second exterior marking;
the first exterior marking being positioned on the first exterior surface;
the second exterior marking being positioned on the second exterior surface; and
the first exterior marking being different in shape from the second exterior marking.

9. The door holding apparatus of claim 1, wherein the magnet is cylindrical in shape.

10. The door holding apparatus of claim 1, further comprising:
a slanted length of the slanted wall parallel to the top surface being less than a first exterior length of the first exterior wall parallel to the top surface; and
a the slanted length being less than a second exterior length of the second exterior wall parallel to the top surface.

11. The door holding apparatus of claim 1, wherein the block is constructed of a pliable material.

12. A door holding apparatus, comprising:
a block;
a magnet;
the block comprising a top surface, a bottom surface, a first exterior wall, a first interior wall, a second exterior wall, a second interior wall, and a slanted wall;
the top surface being oppositely positioned from the bottom surface about the block;
the first exterior wall being oppositely positioned from the second interior wall about the block;
the second exterior wall being oppositely positioned from the first interior wall about the block;
the slanted wall being positioned between the first interior wall and the second interior wall;
the slanted wall being angularly offset from the first interior wall;
the slanted surface being angularly offset from the second interior wall;
the magnet being attached to the block;
the magnet being cylindrical in shape;
a first exterior marking being positioned on the first exterior surface;
a second exterior marking being positioned on the second exterior surface; and
the first exterior marking being different in shape from the second exterior marking.

13. The door holding apparatus of claim 12, further comprising:
the top surface being parallel to the bottom surface;
the first exterior wall being parallel to the second interior wall;
the second exterior wall being parallel to the first interior wall;
the top surface being perpendicular to the first exterior wall;
the first exterior wall being perpendicular to the second exterior wall;
the slanted wall being perpendicular to the top surface;
a first exterior length of the first exterior wall parallel to the top surface being equal to a second exterior length of the second exterior wall parallel to the top surface; and
a first interior length of the first interior wall parallel to the top surface being equal to a second exterior length of the second interior wall parallel to the top surface.

14. The door holding apparatus of claim 12, further comprising:
the magnet being positioned on the first interior wall;
the block further comprising a magnet recess;
the magnet being arranged within the magnet recess; and
the magnet being flush with the first interior wall.

15. The door holding apparatus of claim 12, further comprising:
the slanted wall being flat;
a first slanted angle between the first interior wall and the slanted wall being between 30 and 60 degrees;
a second slanted angle between the second interior wall and the slanted wall being between 30 and 60 degrees; and
the first slanted angle and the second slanted angle being equal.

16. The door holding apparatus of claim 12, further comprising:
a slanted length of the slanted wall parallel to the top surface being less than a first exterior length of the first exterior wall parallel to the top surface; and
a the slanted length being less than a second exterior length of the second exterior wall parallel to the top surface; and
the block being constructed of a pliable material

17. A door holding apparatus, comprising:
a block;
the block comprising a top surface, a bottom surface, a first exterior wall, a first interior wall, a second exterior wall, a second interior wall, and a slanted wall;
the top surface being oppositely positioned from the bottom surface about the block;
the first exterior wall being oppositely positioned from the second interior wall about the block;
the second exterior wall being oppositely positioned from the first interior wall about the block;
the slanted wall being positioned between the first interior wall and the second interior wall;
the slanted wall being angularly offset from the first interior wall;
the slanted surface being angularly offset from the second interior wall;
the top surface being parallel to the bottom surface;
the first exterior wall being parallel to the second interior wall;
the second exterior wall being parallel to the first interior wall;
the top surface being perpendicular to the first exterior wall;
the first exterior wall being perpendicular to the second exterior wall;
the slanted wall being flat;
the slanted wall being perpendicular to the top surface;
a first slanted angle between the first interior wall and the slanted wall being between 30 and 60 degrees; and
a second slanted angle between the second interior wall and the slanted wall being between 30 and 60 degrees.

18. The door holding apparatus of claim 17, further comprising:
a magnet;
the magnet being cylindrical in shape;
the block further comprising a magnet recess;
the magnet recess being positioned on the first interior wall; and
the magnet being flush with the first interior wall.

19. The door holding apparatus of claim 17, further comprising:
a first exterior length of the first exterior wall parallel to the top surface being equal to a second exterior length of the second exterior wall parallel to the top surface; and
a first interior length of the first interior wall parallel to the top surface being equal to a second exterior length of the second interior wall parallel to the top surface;
the first slanted angle and the second slanted angle being equal;
a slanted length of the slanted wall parallel to the top surface being less than the first exterior length; and
the slanted length being less than the second exterior length.

20. The door holding apparatus of claim 17, further comprising:
a first exterior marking;
a second exterior marking;
the first exterior marking being positioned on the first exterior surface;
the second exterior marking being positioned on the second exterior surface;
the first exterior marking being different in shape from the second exterior marking; and
the block being constructed of a pliable material.
